(19) United States
(12) Patent Application Publication
(10) Pub. No.: US 2009/0168104 A1
(43) Pub. Date: Jul. 2, 2009

(54) PRINTING DEVICE, PRINT CONTROL DEVICE, PRINTING SYSTEM AND COMPUTER-READABLE RECORD MEDIUM

(75) Inventors: Masaaki WAKIZAKA, Aichi-ken (JP); Koji AKAGI, Ama-gun (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/345,482

(22) Filed: Dec. 29, 2008

(30) Foreign Application Priority Data
Dec. 28, 2007 (JP) 2007-338818

(51) Int. Cl. G06F 3/12; H04N 1/04

(52) U.S. Cl. 358/1.15; 358/474

(57) ABSTRACT

There is provided a computer-readable record medium storing computer-readable instructions that cause a print control device (for controlling a first printing unit which prints a document image on a sheet) to execute a positional data determination step of determining positional data representing positions of one or more fill-in areas for document image data corresponding to the document image, an addition instruction step of instructing the first printing unit to add an identifier (to be used for acquiring the positional data determined by the positional data determination step) to the sheet, and a print instruction step of instructing the first printing unit to execute the printing of the document image corresponding to the document image data on the sheet to which the identifier is added according to the instruction by the addition instruction step.

### CROSS-REFERENCE TO RELATED APPLICATION

This application claims priority under 35 U.S.C. §119 from Japanese Patent Application No. 2007-338818 filed on Dec. 28, 2007. The entire subject matter of the application is incorporated herein by reference.

### BACKGROUND

1. Technical Field

The present invention relates to a printing device, a print control device, a printing system and a computer-readable record medium storing a print control program.

2. Prior Art

There are cases where a document (e.g. printed matter) after being used includes secret information (information that must be kept from others), confidential information, etc. printed on or written into the document. If such a document is discarded without being appropriately processed or is reused as back side-printed paper (paper already printed on one side), the confidential information, etc. can leak out and cause various troubles from the viewpoint of personal information protection, etc. In order to eliminate such problems, a variety of techniques have been proposed in regard to the so-called “concealment printing” (concealing already printed information by executing overlay printing on the document printed with confidential information).

For example, in a technique disclosed in Japanese Patent Provisional Publication No. 2005-242864 (hereinafter referred to as a “patent document #1”), the whole of a document is scanned to check whether each area of the document has been printed on or not. If a scanned area of the document has been printed on, fill-in printing (filling in a specified area by printing) is executed to the area.

### SUMMARY OF THE INVENTION

Meanwhile, in a technique disclosed in Japanese Patent Provisional Publication No. 2007-10809 (hereinafter referred to as a “patent document #2”), the whole of a document is scanned and when a fill-in target character (a character as a target of the fill-in printing) is detected in (extracted from) the scanned area, the fill-in printing is executed on the detected character.

However, both of the above techniques (patent documents #1 and #2) involve a disadvantage of long processing time since the whole of a document has to be scanned prior to the execution of the fill-in printing.

The present invention, which has been made in consideration of the above problems, is advantageous in that a printing device, a print control device, a printing system and a computer-readable record medium (storing a print control program), capable of realizing quick determination of appropriate fill-in areas and reduced processing time for the fill-in printing, can be provided.

In accordance with an aspect of the present invention, there is provided a printing device comprising a scanning unit which scans and recognizes an identifier which has been added to a printed sheet to be used for determining one or more fill-in areas, a determination unit which determines the fill-in areas for the printed sheet based on the identifier recognized by the scanning unit, and a fill-in printing unit which fills in the fill-in areas determined by the determination unit by executing printing on the printed sheet.

With the printing device configured as above, the identifier (to be used for determining the fill-in areas) which has been added to the printed sheet is scanned and recognized, the fill-in areas for the printed sheet are determined based on the recognized identifier, and the determined fill-in areas are filled in by printing. Therefore, appropriate fill-in areas can be determined in a remarkably shorter time and the processing time necessary for the fill-in printing can be reduced compared to cases where the fill-in areas are determined by scanning the whole of the printed sheet and analyzing the scanned image.

Further, since the identifier to be used for determining the fill-in areas has been added to the printed sheet itself, the possibility of losing the identifier (necessary for determining the fill-in areas) is extremely low, which is highly convenient for the user.

Incidentally, the “sheet” in this specification (including the above description of the printing device) can mean any type of print medium that can be printed on by a printing device, irrespective of the shape, material, etc. of the print medium.

In accordance with an aspect of the present invention, there is provided a computer-readable record medium storing computer-readable instructions that cause a print control device (for controlling a first printing unit which prints a document image on a sheet) to execute a positional data determination step of determining positional data representing positions of one or more fill-in areas for document image data corresponding to the document image, an addition instruction step of instructing the first printing unit to add an identifier (to be used for acquiring the positional data determined by the positional data determination step) to the sheet, and a print instruction step of instructing the first printing unit to execute the printing of the document image corresponding to the document image data on the sheet to which the identifier is added according to the instruction by the addition instruction step.

By making the print control device execute the computer-readable instructions stored in the computer-readable record medium, positional data representing the positions of one or more fill-in areas are determined for the document image data (positional data determination step), the first printing unit is instructed to add an identifier to be used for acquiring the positional data determined by the positional data determination step to the sheet (addition instruction step), and the first printing unit is instructed to execute the printing of the document image on the sheet to which the identifier is added (print instruction step). Consequently, the identifier to be used for acquiring the positional data representing the positions of the fill-in areas is added by the first printing unit to the sheet printed with the document image. Thus, when the fill-in printing is executed to the sheet, the positional data can be acquired by use of the identifier added to the sheet and the fill-in areas can be determined based on the acquired positional data, by which appropriate fill-in areas can be determined quickly and the processing time necessary for the fill-in printing can be shortened.

Further, since the identifier to be used for acquiring the positional data is added to the sheet (printed with the document image) itself, the possibility of losing the identifier (necessary for acquiring the positional data and determining the fill-in areas for the fill-in printing on the document image) is extremely low, which is highly convenient for the user.

In accordance with an aspect of the present invention, there is provided a print control device for controlling a first printing unit which prints a document image on a sheet. The print control device comprises a positional data determination unit which determines positional data representing positions of one or more fill-in areas for document image data corresponding to the document image, an addition instruction unit which instructs the first printing unit to add an identifier (to be used for acquiring the positional data determined by the positional data determination unit) to the sheet, and a print instruction unit which instructs the first printing unit to execute the printing of the document image corresponding to the document image data on the sheet to which the identifier is added according to the instruction by the addition instruction unit.

With the print control device configured as above, effects similar to those of the computer-readable record medium described above can be achieved.

In accordance with an aspect of the present invention, there is provided a printing system comprising a first printing unit which prints a document image on a sheet and a print control device which controls the first printing unit. The print control device includes a positional data determination unit which determines positional data representing positions of one or more fill-in areas for document image data corresponding to the document image, an addition instruction unit which instructs the first printing unit to add an identifier (to be used for acquiring the positional data determined by the positional data determination unit) to the sheet, and a print instruction unit which instructs the first printing unit to execute the printing of the document image corresponding to the document image data on the sheet to which the identifier is added according to the instruction by the addition instruction unit.

With the printing system configured as above, effects similar to those of the computer-readable record medium described above can be achieved.

Other objects, features and advantages of the present invention will become more apparent from the consideration of the following detailed description taken in conjunction with the accompanying drawings.

### BRIEF DESCRIPTION OF THE ACCOMPANYING DRAWINGS

FIG. 1 is a block diagram showing the overall composition of a printing system in accordance with an embodiment of the present invention.

FIG. 2A is an explanatory drawing schematically showing the flow of a confidential document preparation process which is executed by a PC included in the printing system of FIG. 1.

FIG. 2B is an explanatory drawing schematically showing the flow of a fill-in printing process which is executed by a second MFP included in the printing system of FIG. 1.

FIG. 3 is a block diagram showing an example of the electrical configuration of the printing system shown in FIG. 1.

FIG. 4A is a schematic plan view showing the configuration of a printer which is installed in the second MFP.

FIG. 4B is a partial cross-sectional view showing the outline of the cross-sectional structure of a media sensor of the printer which is used for scanning a bar code.

FIG. 5 is an explanatory drawing showing examples of a format registration screen 80 which is displayed on a display unit of the PC when the confidential document preparation process is executed by the PC.

FIG. 6 is a schematic diagram showing an example of the contents of a management format table which is used by a server included in the printing system of FIG. 1.

FIG. 7 is a schematic diagram showing an example of the contents of a fill-in printing history table which is used by the server.

FIG. 8 is a flow chart showing the confidential document preparation process executed by the PC.

FIG. 9 is a flow chart showing a format registration process which is included in the confidential document preparation process of FIG. 8.

FIG. 10 is a flow chart showing a format selection process which is included in the confidential document preparation process of FIG. 8.

FIG. 11 is a flow chart showing a fill-in printing process which is executed by the second MFP.

FIG. 12 is a flow chart showing a fill-in area determination process which is included in the fill-in printing process of FIG. 11.

FIG. 13 is an explanatory drawing showing examples of a confidential part specification screen which is displayed on an LCD of the second MFP during the execution of the fill-in area determination process.

### DETAILED DESCRIPTION OF THE EMBODIMENT

Referring now to the drawings, a description will be given in detail of a preferred embodiment in accordance with the present invention.

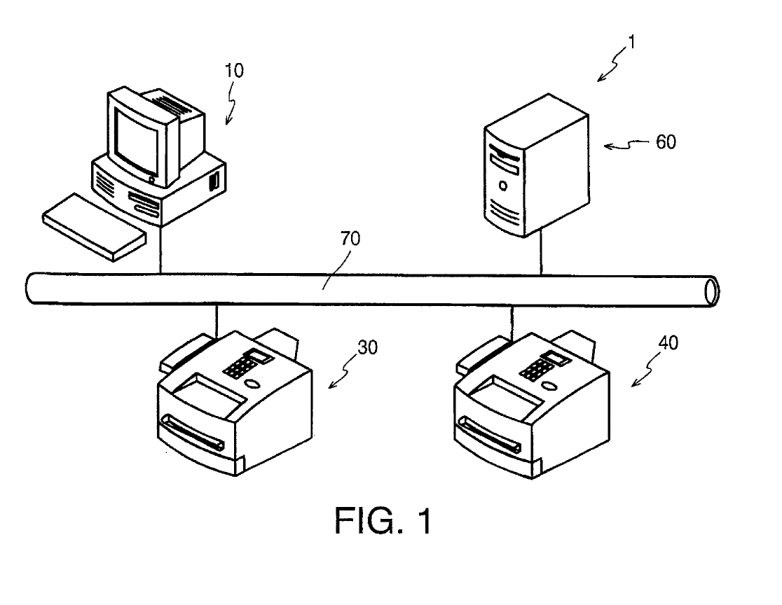

FIG. 1 is a block diagram showing the overall composition of a printing system 1 in accordance with an embodiment of the present invention. The printing system 1 shown in FIG. 1 includes a PC (Personal Computer) 10, a first MFP (Multi-Function Peripheral) 30, a second MFP 40 and a server 60 which area connected together by a LAN (Local Area Network) 70. Each MFP (30, 40) includes a printer for forming (printing) a document image on a sheet (example of a print medium) such as paper.

In the printing system 1, the PC 10 controls the first MFP 30 to make the first MFP 30 print out confidential documents. Meanwhile, the second MFP 40 is used for executing fill-in printing on a confidential document (filling in a specified area of the confidential document by printing in order to conceal the area). The printing system 1 of this embodiment is especially capable of quickly determining appropriate fill-in areas (areas of a confidential document that should be filled in for concealment) and shortening the processing time necessary for the fill-in printing.

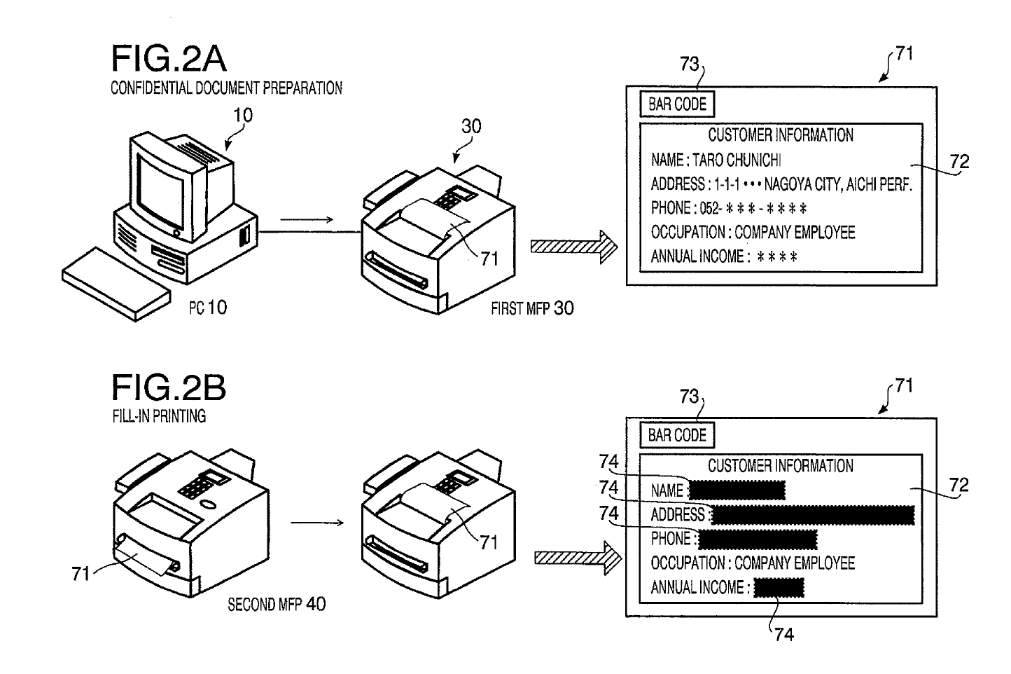

The outline of processes which are executed in the printing system 1 of FIG. 1 will be described below with reference to FIGS. 2A and 2B. FIG. 2A is an explanatory drawing schematically showing the flow of a confidential document preparation process which is executed by the PC 10.

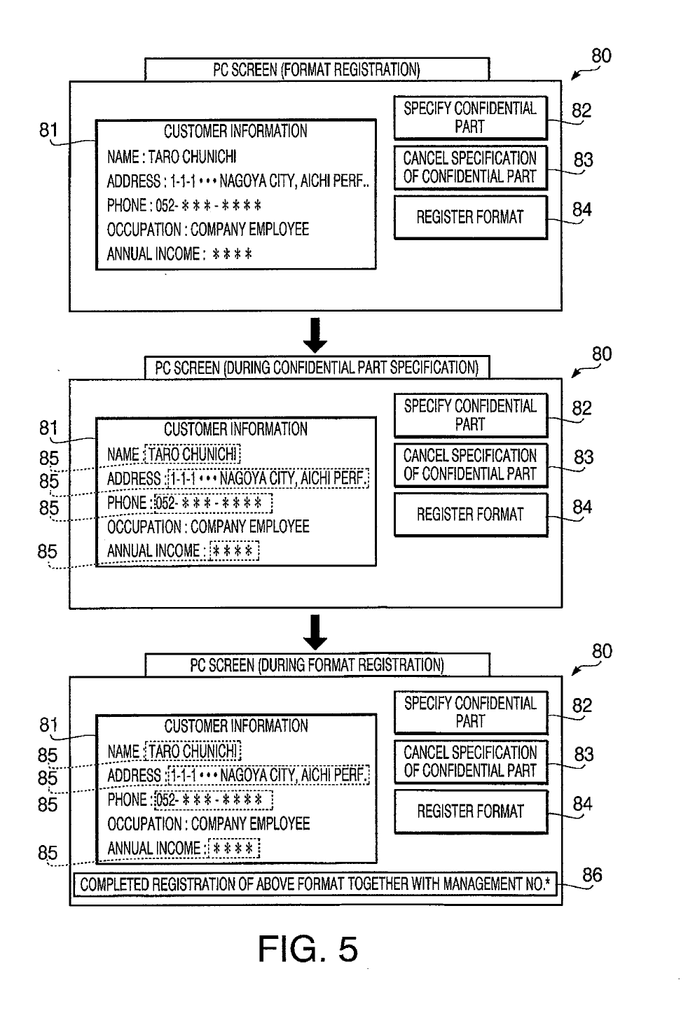

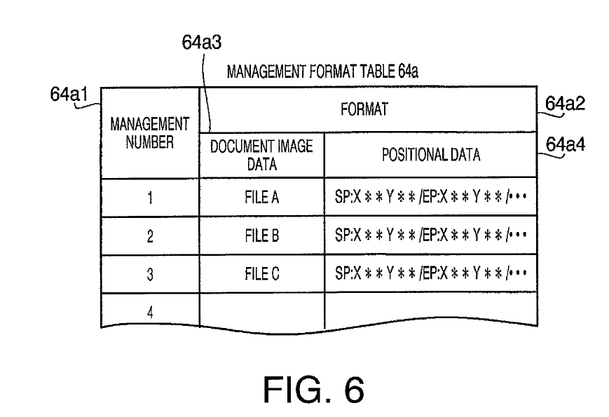

In the confidential document preparation process shown in FIG. 2A, the PC 10 controls the first MFP 30 to make it prepare a confidential document 71 to which a bar code 73 and a document image 72 corresponding to document image data have been added by printing. The bar code 73 (example of an identifier) is added to the confidential document 71 to be used for determining the fill-in areas in the document image 72 (details will be explained later referring to FIGS. 5 and 6).

It is desirable that the bar code 73 (identifier) be added to the margin of the confidential document 71, by which the scanning/recognition of the bar code 73 can be executed correctly and the document image 72 on the confidential document 71 can be prevented from being unrecognizable.

Incidentally, the “document image data” in this specification can mean, for example, a document file, a spreadsheet file, an image file, etc. The expression “document image” collectively means (one or more) characters, (one or more) images, etc. formed on a sheet (print medium) according to the document image data. Thus, the “document image” can be made up of characters only, images only, characters and images, etc.

FIG. 2B is an explanatory drawing schematically showing the flow of a fill-in printing process which is executed by the second MFP 40. When the confidential document 71 which has been printed on as above is placed on a sheet feed tray of the second MFP 40 as shown in FIG. 2B, the second MFP 40 scans the bar code 73 (identifier for determining the fill-in areas) which has been added to the confidential document 71, determines the fill-in areas 74 on the confidential document 71 based on the bar code 73, and then fills in the determined fill-in areas 74 by printing.

With the printing system 1 of this embodiment, appropriate fill-in areas 74 can be determined quickly by use of the bar code 73 added to the confidential document 71 and the processing time necessary for the fill-in printing can be shortened, in cases where the user wants to discard the confidential document 71, where the user wants to conceal confidential parts of the document 71 when the document 71 has to be transferred to a third party, etc.

Further, since the bar code 73 to be used for determining the fill-in areas is added to the confidential document 71 itself, the possibility of losing the bar code 73 (necessary for determining the fill-in areas) is extremely low, which is highly convenient for the user.

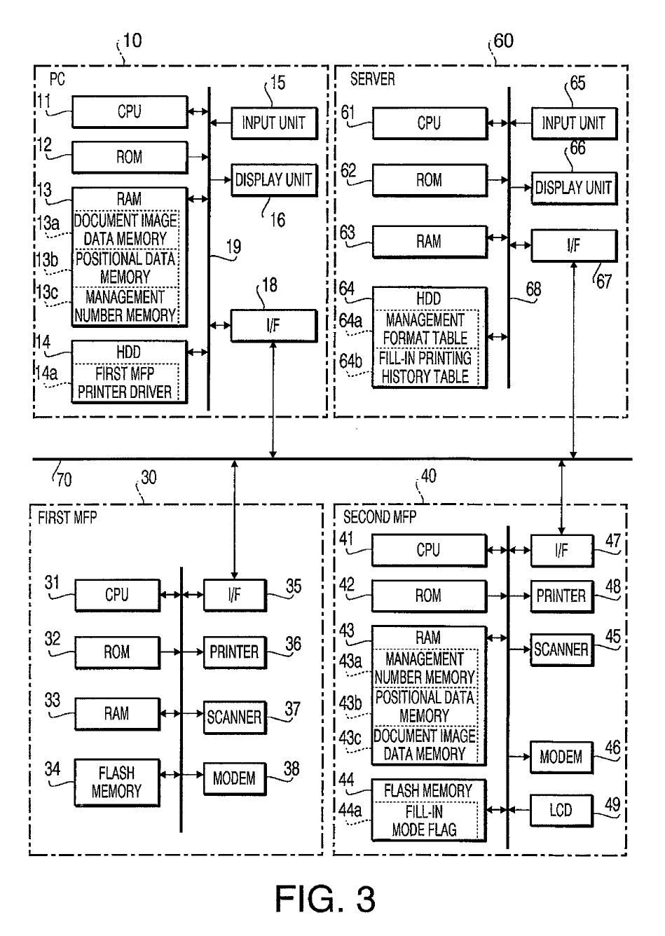

FIG. 3 is a block diagram showing an example of the electrical configuration of the printing system 1 shown in FIG. 1. As shown in FIG. 3, the PC 10 includes a CPU (Central Processing Unit) 11, a ROM (Read Only Memory) 12, a RAM (Random Access Memory) 13, an HDD (Hard Disk Drive) 14, an input unit 15, a display unit 16 and an I/F (interface) 18 (for the connection with the LAN 70), which are connected together by a bus line 19.

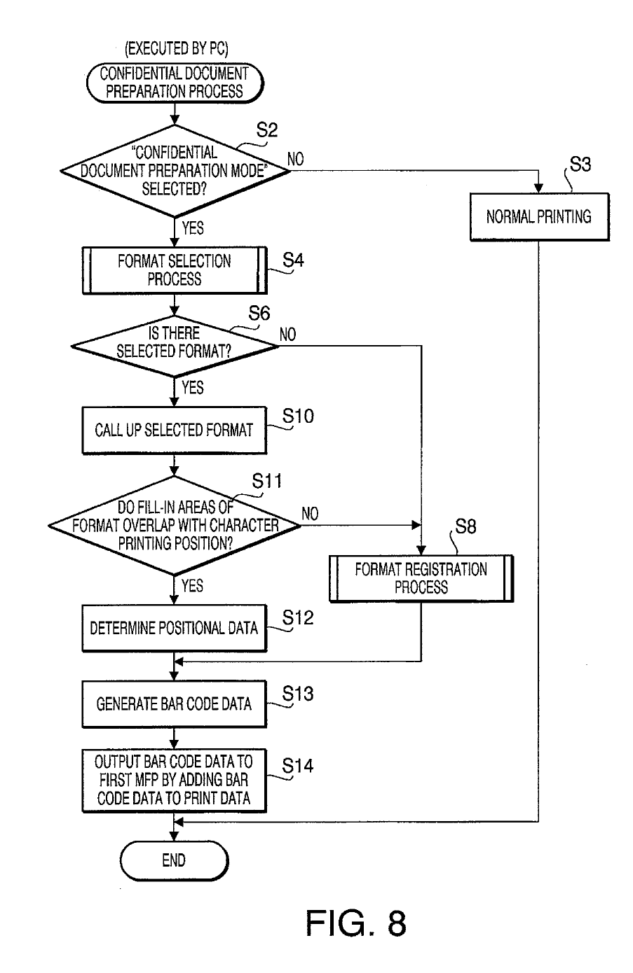

The CPU 11, as a central processing unit for the centralized control of the PC 10, executes various programs (e.g. flow charts of FIGS. 8-10).

The ROM 12 is a non-rewritable memory storing various control programs to be executed by the CPU 11 and data necessary for the execution of the control programs by the CPU 11.

The RAM 13 is a memory for temporarily storing programs and data necessary for the execution of various processes by the CPU 11. The RAM 13 includes a document image data memory 13a, a positional data memory 13b and a management number memory 13c. The document image data memory 13a is used for storing document image data as the target of printing (print target) specified by the user. The positional data memory 13b is used for storing positional data representing the positions of the fill-in areas (determined in the confidential document preparation process (FIG. 8) which will be described later). The management number memory 13c is used for storing a management number (example of management data) which is held by the bar code 73 (see FIGS. 2A and 2B) for calling up the positional data. The management number will be explained later with reference to FIG. 6.

The HDD 14 stores a first MFP printer driver 14a (printer driver for controlling the first MFP 30). The processes shown in the flow charts of FIGS. 8-10 are executed by the first MFP printer driver 14a.

The input unit 15 (including a keyboard, mouse, etc.) is a unit for letting the user input data and instructions (commands) to the PC 10.

The display unit 16 (CRT (Cathode-Ray Tube), LCD (Liquid Crystal Display), etc.) is a unit for displaying characters, images, etc. to let the user visually check the process currently executed by the PC 10, inputted data, etc.

The first MFP 30 includes a CPU 31, a ROM 32, a RAM 33, a flash memory 34, an I/F 35 (for the connection with the LAN 70), a printer 36, a scanner 37 and a modem 38, which are connected together by a bus line. The first MFP 30 is a peripheral device having various functions such as the so-called facsimile function, PC print function, scanner function and copy function. Especially, the first MFP 30 has the function of preparing a confidential document 71 (see FIG. 2A) under the control of the PC 10.

The second MFP 40 includes a CPU 41, a ROM 42, a RAM 43, a flash memory 44, a scanner 45, a modem 46, an I/F 47 (for the connection with the LAN 70), a printer 48 and an LCD (Liquid Crystal Display) 49, which are connected together by a bus line.

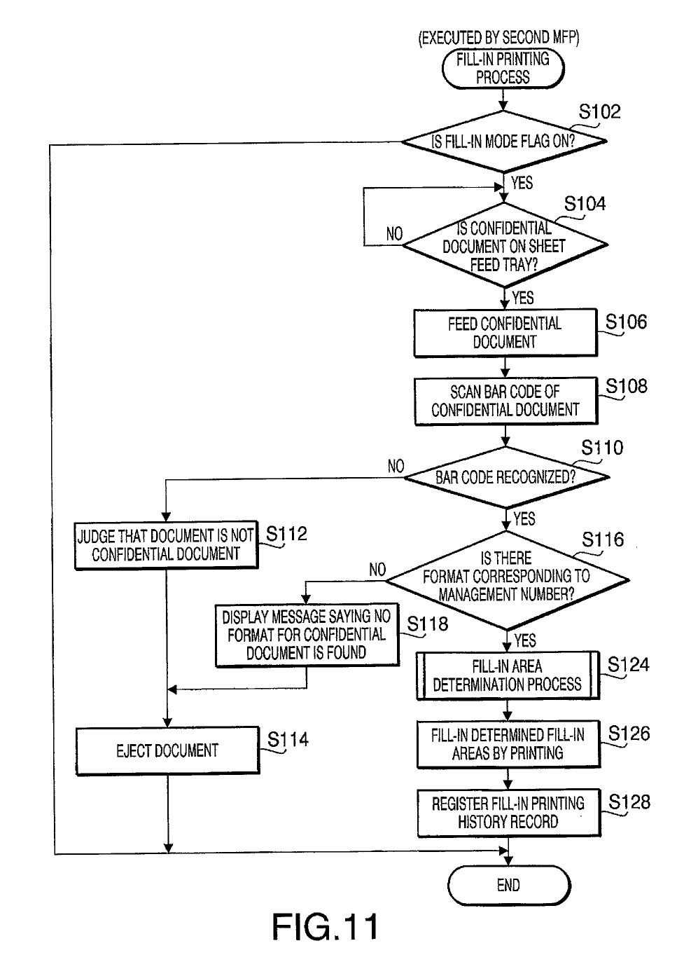

The CPU 41, as a central processing unit for the centralized control of the second MFP 40, executes various programs (e.g. flow chart of FIG. 11).

The ROM 42 is a non-rewritable memory storing various control programs to be executed by the CPU 41 and data necessary for the execution of the control programs by the CPU 41.

The RAM 43 is a memory for temporarily storing programs and data necessary for the execution of various processes by the CPU 41. The RAM 43 includes a management number memory 43a, a positional data memory 43b and a document image data memory 43c.

The management number memory 43a is used for storing the management number which is acquired by scanning the bar code 73 of the confidential document 71. The management number will be explained later with reference to FIG. 6.

The positional data memory 43b and the document image data memory 43c are used for storing positional data and document image data which are called up from a management format table 64a (see FIG. 6) of the server 60 based on the management number acquired from the bar code 73.

The flash memory 44 is a rewritable nonvolatile memory storing a fill-in mode flag 44a. The fill-in mode flag 44a is turned ON/OFF when a fill-in mode of the second MFP 40 is enabled/disabled by the user.

The second MFP 40 also has various functions such as the facsimile function, PC print function, scanner function and copy function. Especially, the printer 48 of the second MFP 40 is equipped with a mechanism (media sensor 50, etc.) capable of scanning the bar code 73 added to the confidential document 71 and executes the fill-in printing on the confidential document 71 according to the bar code 73 when the fill-in mode flag 44a has been turned ON.

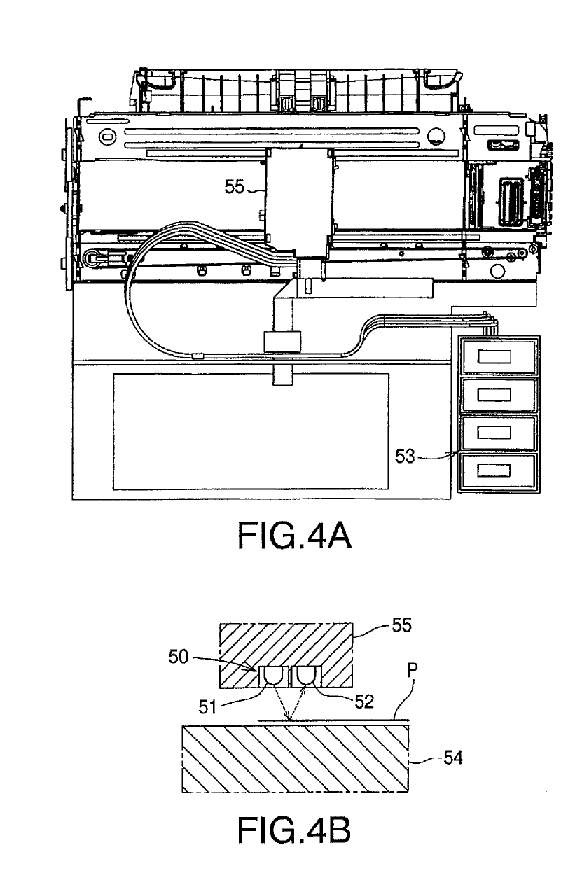

The printer 48 of the second MFP 40 will be described in detail below with reference to FIGS. 4A and 4B. FIG. 4A is a schematic plan view showing the configuration of the printer 48 which is installed in the second MFP 40. As shown in FIG. 4A, the printer 48 includes a carriage 55 (on which a print head is mounted) which is movable to and fro in the sheet width direction (horizontal direction in FIG. 4A).

The print head mounted on the carriage 55 receives ink supplied from an ink tank 53 and discharges minute ink drops onto the sheet. With the movement of the carriage 55 (equipped with the print head) in the sheet width direction, the printer 48 carries out the printing on the sheet P being fed on a platen 54 (see FIG. 4B) beneath the print head. Especially when the sheet P is a confidential document 71, the printer 48 scans the bar code 73 of the confidential document 71 (see FIG. 2B) and fills in the fill-in areas of the confidential document 71 (determined based on the bar code 73) by printing.

FIG. 4B is a partial cross-sectional view showing the outline of the cross-sectional structure of a media sensor 50 which is used for the scanning of the bar code 73. As shown in FIG. 4B, the media sensor 50 is mounted on the carriage 55 of the printer 48. The media sensor 50 includes an LED (Light-Emitting Diode) 51 for emitting light onto the sheet P being fed on the platen 54 and an optical sensor 52 for detecting reflected light from the sheet P. By use of a platen 54 having a color of low brightness, the presence/absence of the sheet P can be detected by the media sensor 50 based on variations in the amount of the reflected light.

In this embodiment, the media sensor 50 is used also for the scanning of the bar code 73 of the confidential document 71 (see FIG. 2B). Since the media sensor 50 for the detection of the presence/absence of the sheet P is also used for the scanning of the bar code 73 in this embodiment (without the need of adding new components for the bar code scanning), cost rise and enlargement of the device can be avoided.

Further, since the media sensor 50 (mounted on the carriage 55) can be moved to an fro in the sheet width direction, the scanning of the bar code 73 is possible irrespective of the position of the bar code 73 printed on the sheet P, by moving the media sensor 50 (carriage 55) in the sheet width direction and/or feeding the sheet P on the platen 54 with a feeding mechanism (unshown).

Returning to FIG. 3, the server 60 includes a CPU 61, a ROM 62, a RAM 63, an HDD 64, an input unit 65, a display unit 66 and an I/F 67 (for the connection with the LAN 70), which are connected together by a bus line 68.

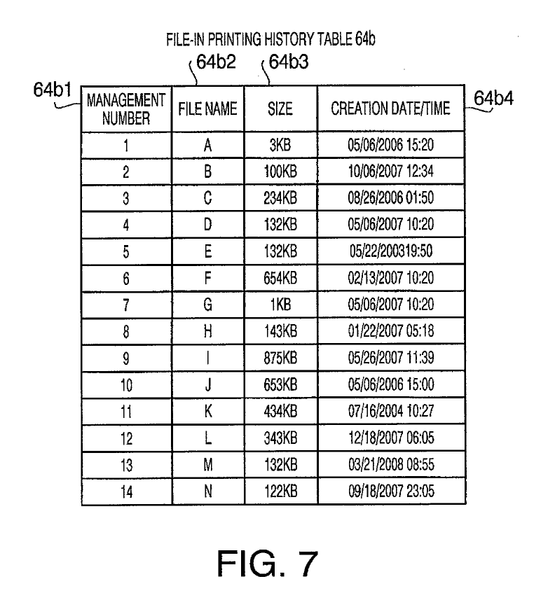

The HDD 64 stores the aforementioned management format table 64a (for storing the positional data representing the positions of the fill-in areas) and a fill-in printing history table 64b for storing history records of the fill-in printing. The fill-in printing history table 64b will be explained later referring to FIG. 7. The management format table 64a will be explained below referring to FIGS. 5 and 6.

The flow of a process which is executed by the PC 10 for the determination of the positional data and the registration of the positional data in the management format table 64a will be described below with reference to FIG. 5. FIG. 5 is an explanatory drawing showing examples of a format registration screen 80 which is displayed on the display unit 16 of the PC 10 when the confidential document preparation process (see FIG. 8) is executed by the PC 10.

As shown in FIG. 5, the format registration screen 80 includes a document image display area 81, a confidential part specification icon 82, a confidential part specification cancellation icon 83 and a format registration icon 84.

The document image display area 81 is an area for preview-displaying document image data as the print target. The confidential part specification icon 82 is an icon for receiving the user's instruction for starting the specification of the fill-in areas. When the instruction to the confidential part specification icon 82 is inputted by the user (i.e. when the confidential part specification icon 82 is selected by the user), the PC 10 receives the user's input for specifying the fill-in areas (i.e. specifying each area that should be set as a fill-in area) by letting the user specify character strings included in the document image preview-displayed in the document image display area 81.

When the fill-in areas 85 have been specified by the user by operating the input unit 15 (e.g. mouse), the specified fill-in areas 85 are displayed in a specific display style (highlighted, surrounded by frames, etc.) to be distinguishable from other areas. Incidentally, by displaying the specified fill-in areas 85 so that characters in the fill-in areas are visually recognizable as shown in FIG. 5 (without totally filling in the fill-in areas 85), the user is allowed to read the characters (target of fill-in printing) and judge whether the fill-in printing on the characters is really necessary or not.

The confidential part specification cancellation icon 83 is an icon for receiving the user's instruction for canceling the specification of a confidential part (fill-in area). When the instruction to the confidential part specification cancellation icon 83 is inputted by the user (i.e. when the confidential part specification cancellation icon 83 is selected by the user), the specification of a fill-in area 85 (selected by the user from all the fill-in areas 85 displayed in the document image display area 81) is canceled.

The format registration icon 84 is an icon for receiving the users instruction for registering the fill-in areas 85 displayed in the document image display area 81. When the instruction to the format registration icon 84 is inputted by the user (i.e. when the format registration icon 84 is selected by the user), positional data representing the positions of the fill-in areas 85 currently displayed in the document image display area 81 is registered (stored) in the management format table 64a (see FIG. 6) as a format. After the registration of a format is completed, the user is informed (by a message 86) of a management number which can be used for calling up the format.

FIG. 6 is a schematic diagram showing an example of the contents of the management format table 64a. As shown in FIG. 6, the management format table 64a stores each format 64a2 while associating it with a management number 64a1 (example of management data).

In each format 64a2, document image data 64b3 corresponding to the document image 72 of the confidential document 71 (to which the fill-in printing according to the positional data 64a4 is executed) is stored while associating it with the positional data 64a4 as shown in FIG. 6. The positional data 64a4 includes one or more coordinate pairs each of which includes the (X, Y) coordinates of the starting point and endpoint of a fill-in area 85.

For the fill-in printing on a confidential document 71, the second MFP 40 acquires the management number from the bar code 73 of the confidential document 71 (details will be described later with reference to FIG. 11). By using the format corresponding to the acquired management number, the second MFP 40 determines the fill-in areas appropriate for the confidential document 71 and then executes the fill-in printing to the determined fill-in areas.

FIG. 7 is a schematic diagram showing an example of the contents of the fill-in printing history table 64b. The fill-in printing history table 64b stores history records of the fill-in printing executed by the second MFP 40. Specifically, in each history record, a management number 64b1 representing a format that was used for a fill-in printing process is associated with the file name 64b2, file size 64b3 and file creation date/time 64b4 of a confidential document 71 for which the format was used. Here, “the file name, file size and file creation date/time of a confidential document 71” means the file name, file size and file creation date/time of the document image data as the original data of the document image 72 printed on the confidential document 71.

As above, when a confidential document 71 is created for a piece of document image data, a format representing the fill-in areas is generated and registered in the management format table 64a (see FIG. 6). Thereafter, when the fill-in printing has been executed to the confidential document 71 according to the format, the file name, file size and file creation date/time of the document image data as the original data of the confidential document 71 are stored in the fill-in printing history table 64b while associating them with the management number of the format.

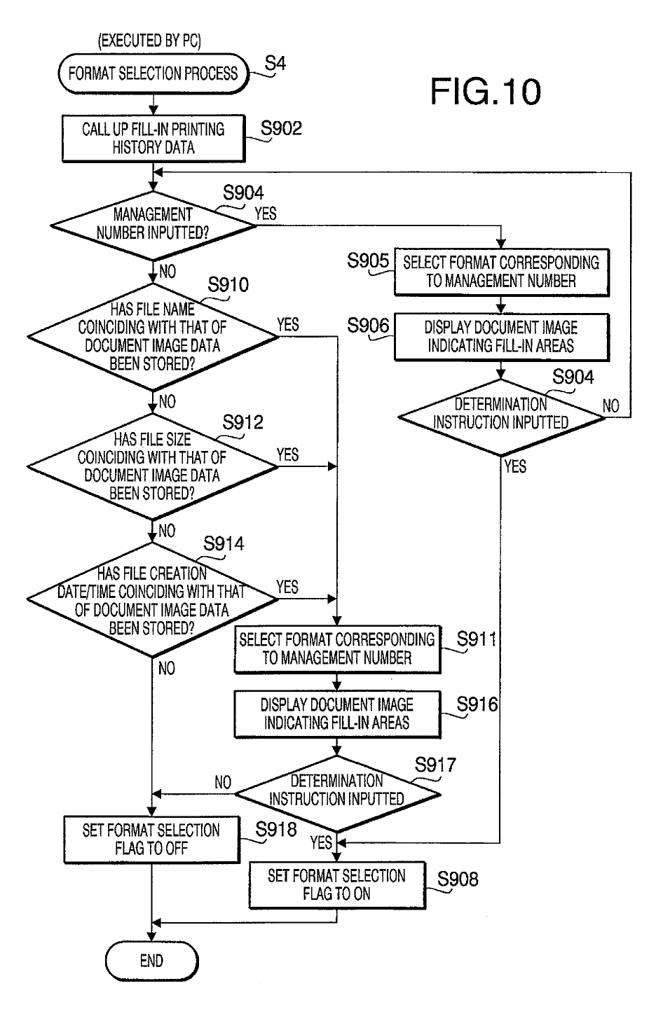

Therefore, when the confidential document 71 is prepared again later based on the same document image data, the management number of the format that has already been registered for the document image data can be acquired and used, by searching the fill-in printing history table 64b using the file name, file size and/or file creation date/time of the document image data as search conditions (details will be described later referring to FIG. 10).

Incidentally, the management format table 64a (FIG. 6) and the fill-in printing history table 64b (FIG. 7) in this embodiment are associated with each other by common management numbers. Thus, in the server 60, the positional data is associated with the file name, file size and file creation date/time of the document image data (for which the fill-in areas represented by the positional data were used) via the management number.

FIG. 8 is a flow chart showing the confidential document preparation process which is executed by the PC 10. The confidential document preparation process is started when a piece of document image data is specified and a print instruction for the specified document image data is inputted to the PC 10 by the user.

At the start of the confidential document preparation process (upon reception of the print instruction), the PC 10 judges whether a confidential document preparation mode has been selected by the user or not (S2). If negative in S2 (S2: NO), the PC 10 makes the first MFP 30 execute normal printing of the document image data (S3) and ends the process.

If affirmative in S2 (S2: YES), the PC 10 determines the positional data (representing the positions of the fill-in areas) for the document image data (print target) in subsequent steps S4-S12.

Specifically, the PC 10 first executes a format selection process (S4), in which a format appropriate for the current confidential document preparation process is selected from all the formats registered in the management format table 64a (see FIG. 6). While details will be described later referring to FIG. 10, in the format selection process (S4), a format selection flag indicating the presence/absence of a selected format is set to ON (indicating that there exists a selected format) when a format has been selected.

Subsequently, the PC 10 judges whether or not there exists a selected format (S6). If affirmative in S6 (S6: YES), the PC 10 calls up the format selected in the format selection process (S4) from the management format table 64a (S10), and stores the positional data included in the format 64a2 in the positional data memory 13b (see FIG. 3) while storing the management number 64a1 corresponding to the format 64a2 in the management number memory 13c.

Subsequently, the PC 10 judges whether the fill-in areas represented by the format 64a2 called up in S10 overlap with a character printing position (printing position of a character) in the document image 72 to be printed according to the document image data (print target) (S11). Specifically, the PC 10 in S11 judges whether or not the areas specified by the coordinate pairs (each of which includes (X, Y) coordinates of a starting point and an endpoint) in the positional data 64a4 of the format 64a2 include a character printing position in the document image 72 (print target).

If affirmative in S11 (S11: YES), the PC 10 determines the positional data 64a4 (included in the selected format) as the positional data 64a4 representing the fill-in areas for the document image data (print target) (S12).

Subsequently, the PC 10 generates bar code data to be used for printing a bar code 73 holding the management number 64a1 stored in the management number memory 13c (i.e. management number corresponding to the format which has been called up in S10) on the confidential document 71 (S13) and then outputs the generated bar code data to the first MFP 30 by adding the bar code data to the print data for the printing of the document image 72 (S14), by which the bar code 73 (to be used for acquiring the positional data determined for the document image data) can be added to the confidential document 71 while making the first MFP 30 execute the printing of the document image 72 on the confidential document 71.

Further, since the positional data is determined on condition that the fill-in areas represented by the format are judged to overlap with a character printing position (the position of a character printed according to the document image data), appropriate positional data (positional data corresponding to fill-in areas appropriate for the concealment of characters) can be determined with ease.

On the other hand, if negative in S6 (S6: NO) or S11 (S11 NO), the PC 10 executes a format registration process (S8). In the format registration process (S8), the PC 10 newly determines the positional data based on user inputs (without using any format already stored in the management format table 64a) and registers a format including the newly determined positional data in the management format table 64a.

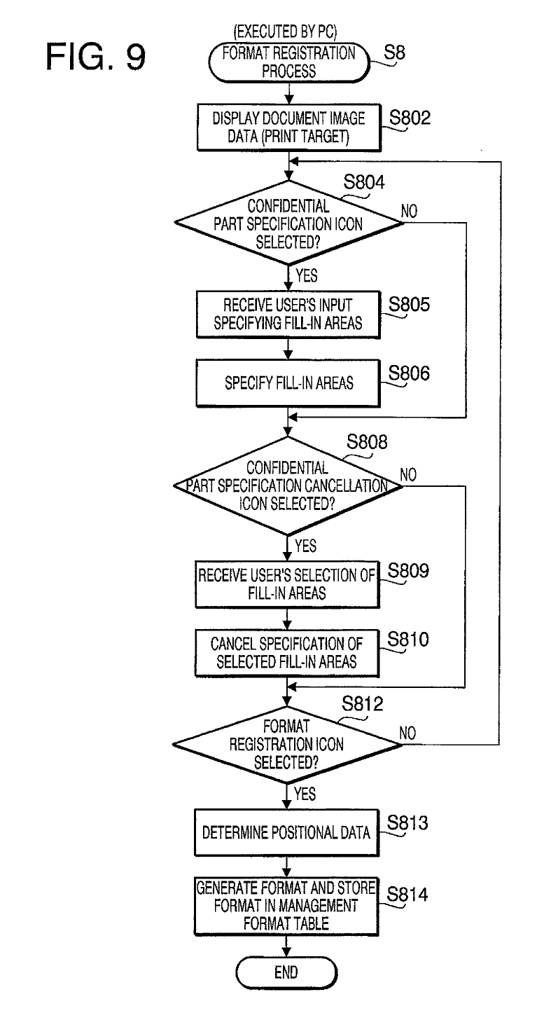

FIG. 9 is a flow chart showing the format registration process (S8 in FIG. 8). At the start of the format registration process (S8), the PC 10 displays the format registration screen 80 on the display unit 16 while preview-displaying the document image 72 (to be printed on the confidential document 71 according to the document image data as the print target) in the document image display area 81 (see FIG. 5) of the format registration screen 80 (S802).

Subsequently, the PC 10 judges whether the confidential part specification icon 82 (see FIG. 5) has been selected by the user (S804). If affirmative in S804 (S804: YES), the PC 10 receives the user's input specifying the fill-in areas (i.e. specifying each area in the displayed document image that should be set as a fill-in area) (S805). According to the received input, the PC 10 newly specifies the fill-in areas and stores the positional data representing the positions of the fill-in areas in the positional data memory 13b (S806). Based on the stored positional data, a display for indicating the fill-in areas 85 is made in the document image display area 81 (see FIG. 5).

Subsequently, the PC 10 judges whether the confidential part specification cancellation icon 83 (see FIG. 5) has been selected by the user (S808). If affirmative in S808 (S808: YES), the PC 10 receives the user's input for selecting a fill-in area 85 from the displayed fill-in areas 85 (see FIG. 5) (S809) and cancels the specification of the fill-in area 85 selected by the user (S810). In other words, part of the positional data (stored in the positional data memory 13b in S806) specified by the user is deleted.

Subsequently, the PC 10 judges whether the format registration icon 84 (see FIG. 5) has been selected by the user (S812). If negative in S812 (S812: NO), the PC 10 returns to S804 and repeats the process from S804. If affirmative in S812 (S812: YES), the PC 10 determines the positional data stored in the positional data memory 13b (representing the fill-in areas 85 currently displayed in the document image display area 81) as the positional data representing the positions of the fill-in areas (S813).

Subsequently, the PC 10 generates a format including the document image data (print target) and the positional data determined in S813 and newly stores the generated format in the management format table 64a (S814). In the case where a new format is stored in the management format table 64a, the format is associated with a unique management number differing from other (already used) management numbers. The new management number associated with the format is stored in the management number memory 13c. At this time, the user is informed (by the message 86 displayed on the format registration screen 80) of the stored management number (see FIG. 5).

By the above format registration process (S8), positional data desired by the user can be determined and stored in the management format table 64a.

Returning to FIG. 8, when a new format has been determined by the format registration process (S8) as above, the PC 10 generates bar code data to be used for printing a bar code 73 (holding the management number corresponding to the new format) on the confidential document 71 (S13) and then outputs the generated bar code data to the first MFP 30 by adding the bar code data to the print data for the printing of the document image (S14).

By the confidential document preparation process (FIG. 8), a confidential document 71 having the bar code 73 (to be used for determining the fill-in areas in the fill-in printing process) can be created (prepared) by use of the first MFP 30. The fill-in printing on the confidential document 71 will be described later referring to FIG. 11.

Since the bar code 73 in this embodiment has only to hold a management number, even an identifier not having a large data capacity (e.g. one-dimensional bar code) can be used as the bar code 73.

FIG. 10 is a flow chart showing the format selection process (S4 in FIG. 8). The format selection process (S4) is executed for selecting a format appropriate for the current confidential document preparation process from the formats already registered in the management format table 64a (see FIG. 6).

First, the PC 10 calls up data stored in the fill-in printing history table 64b (S902). Subsequently, the PC 10 (receiving a user input specifying a management number) judges whether a management number has been inputted or not (S904).

When a management number has been inputted by the user (S904: YES), the PC 10 selects a format corresponding to the management number (S905) and displays the document image indicating the fill-in areas on the display unit 16 based on the document image data (print target) and the positional data of the format (S906). Subsequently, the PC 10 judges whether a determination instruction has been inputted by the user (S907). If negative in S907 (S907: NO), the PC 10 returns to S904 and repeats the process from S904. If affirmative in S907 (S907: YES), the PC 10 sets the format selection flag to ON (indicating that there exists a selected format) (S908) and ends the format selection process of FIG. 10 (S4).

By the step S906, the user is allowed to view the fill-in areas corresponding to the management number inputted by the user himself/herself and thereby judge whether or not the fill-in areas are appropriate for the currently prepared confidential document 71.

If negative in S904 (S904: NO), the PC 10 judges whether a file name coinciding with that of the document image data (print target) has already been stored in the fill-in printing history table 64b (see FIG. 7) (S910).

Incidentally, the “file name coinciding with that of the document image data” is not restricted to a file name totally coinciding with that of the document image data; a file name partially coinciding with that of the document image data may also be regarded as a coinciding file name.

If affirmative in S910 (S910: YES), the PC 10 acquires the management number corresponding to the coinciding file name and selects the format corresponding to the acquired management number (S911). Based on the document image data (print target) and the positional data of the selected format, the PC 10 displays the document image indicating the fill-in areas on the display unit 16 (S916).

If negative in S910 (S910: NO), the PC 10 judges whether a file size coinciding with that of the document image data (print target) has already been stored in the fill-in printing history table 64b (S912).

If affirmative in S912 (S912: YES), the PC 10 acquires the management number corresponding to the coinciding file size and selects the format corresponding to the acquired management number (S911). Based on the document image data print target) and the positional data of the selected format, the PC 10 displays the document image indicating the fill-in areas on the display unit 16 (S916).

If negative in S912 (S912: NO), the PC 10 judges whether a file creation date/time coinciding with that of the document image data (print target) has already been stored in the fill-in printing history table 64b (S914).

If affirmative in S914 (S914: YES), the PC 10 acquires the management number corresponding to the coinciding file creation date/time, selects the format corresponding to the acquired management number (S911), and displays the document image indicating the fill-in areas on the display unit 16 based on the document image data (print target) and the positional data of the selected format (S916).

Subsequently, the PC 10 judges whether the determination instruction has been inputted by the user (S917). If affirmative in S917 (S917: YES), the PC 10 sets the format selection flag to ON (indicating that there exists a selected format) (S908) and ends the format selection process of FIG. 10 (S4). If negative in S917 (S917: NO), the PC 10 sets the format selection flag to OFF (indicating that there exists no selected format) (S918) and ends the format selection process of FIG. 10 (S4). After ending the format selection process (S4), the PC 10 returns to the step S6 of the confidential document preparation process (FIG. 8).

By the above format selection process (S4), when the printing is executed again for document image data for which a format has already been determined (registered), the previously registered format can be selected for the document image data based on the management number (inputted by the user) or the file name, file size or file creation date/time of the document image data. In the confidential document preparation process (FIG. 8), appropriate positional data is determined with ease by use of the selected format, by which the operating load on the user for the determination of the positional data is reduced considerably.

Further, since the document image indicating the fill-in areas (assuring that the selected format is used) is displayed on the screen prior to the determination of the positional data, the user can determine whether to use the selected format or not after viewing the fill-in areas corresponding to the selected (previously stored) format and checking whether the format is appropriate for the current document image or not.

Furthermore, even when a coinciding file name is not found in the search of the fill-in printing history table 64b using the file name as the search condition, the fill-in printing history table 64b is searched by using the file size or file creation date/time as the search condition. Thus, the probability of finding and selecting the format corresponding to the current document image data is high even when the file name of the document image data has been changed, for example.

FIG. 11 is a flow chart showing the fill-in printing process which is executed by the second MFP 40. In the fill-in printing process, fill-in areas to be employed for the confidential document 71 (created by the confidential document preparation process of FIG. 8) are determined and the determined fill-in areas are filled in by printing.

First, the second MFP 40 judges whether its fill-in mode flag 44a has been set to ON or not (S102). The judgment of S102 is made by detecting whether a key of the second MFP 40 for specifying the fill-in mode has been pressed or not, for example. If negative in S102 (S102: NO), the second MFP 40 ends the fill-in printing process of FIG. 11.

If affirmative in S102 (S102: YES), the second MFP 40 judges whether a confidential document 71 has been placed on a sheet feed tray (S104). The judgment of S104 may be made by checking whether a sheet has been placed on a particular sheet feed tray (prescribed for the loading of a confidential document 71), for example.

If negative in S104 (S104: NO), the second MFP 40 stays on standby until the judgment of S104 turns affirmative. If affirmative in S104 (S104: YES), the second MFP 40 feeds the confidential document 71 until its bar code 73 reaches a scannable position of the media sensor 50 (S106).

Subsequently, the second MFP 40 scans the bar code 73 (added to the confidential document 71) with the media sensor 50 (see FIG. 4B) (S108). In cases where the sheet (document) as the processing target is a confidential document 71, a management number is acquired from the scanned bar code 73 and stored in the management number memory 43a (see FIG. 3).

Subsequently, the second MFP 40 judges whether a bar code 73 was successfully recognized or not (S110). If negative in S110 (S110: NO), the second MFP 40 judges that the sheet (document) being processed is not a confidential document 71 (S112), directly ejects the sheet (document) which has been fed (S114) and ends the fill-in printing process of FIG. 11.

If affirmative in S110 (S110: YES), the second MFP 40 judges whether a format corresponding to the management number acquired from the bar code 73 has already been stored in the management format table 64a (S116).

If negative in S116 (S116: NO), the second MFP 40 displays a message (indicating that no format is found) on the LCD 49 (S118) and then advances to the step S114 (ejects the document).

If affirmative in S116 (S116: YES), the second MFP 40 executes a fill-in area determination process (determining the fill-in areas based on the management number) (S124) and fills in the determined fill-in areas by executing printing on the confidential document 71 (S126). Thereafter, the second MFP 40 stores a print history record regarding the step S126 in the fill-in printing history table 64b (see FIG. 7) (S128) and ends the fill-in printing process of FIG. 11.

By the above fill-in printing process (FIG. 11), the fill-in printing on the confidential document 71 can be carried out while determining appropriate fill-in areas quickly, by which the processing time necessary for the fill-in printing can be shortened considerably.

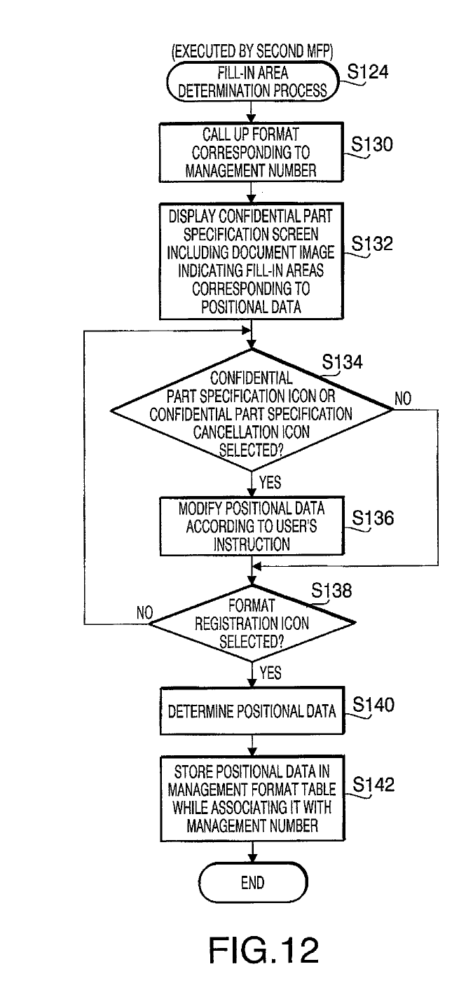

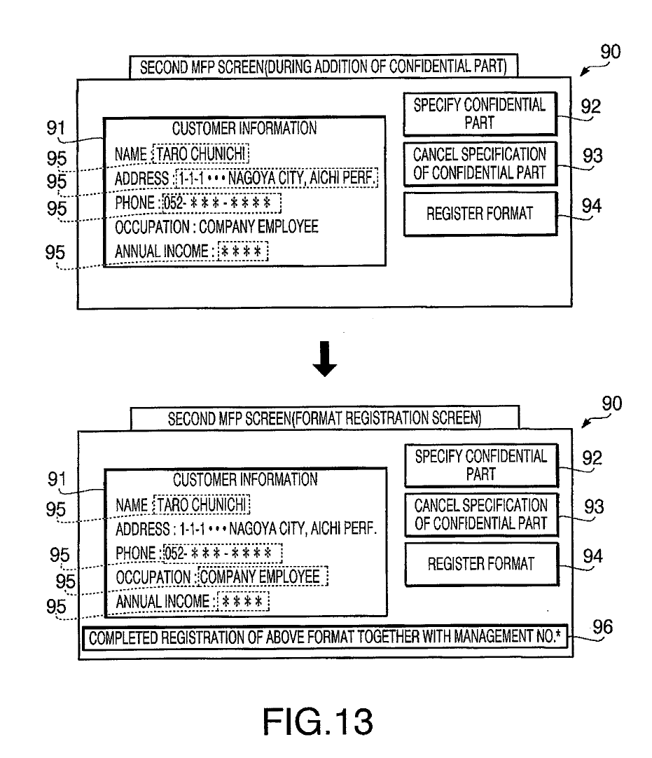

FIG. 12 is a flow chart showing the fill-in area determination process (S124) included in the fill-in printing process (FIG. 11). FIG. 13 is an explanatory drawing showing examples of a confidential part specification screen which is displayed on the LCD 49 of the second MFP 40 during the execution of the fill-in area determination process (S124). The fill-in area determination process (S124) shown in FIG. 12 will be explained below while referring to FIG. 13 as needed.

First, the second MFP 40 calls up the format 64a2 corresponding to the management number from the management format table 64a (see FIG. 6), stores the positional data 64a4 included in the format 64a2 in the positional data memory 43b, and stores the document image data 64a3 in the document image data memory 43c (see FIG. 3) (S130). Subsequently, the second MFP 40 generates a confidential part specification screen 90 based on the document image data 64a3 and the positional data 64a4 and displays the confidential part specification screen 90 on the LCD 49 (S132).

Examples of the confidential part specification screen 90 are shown in FIG. 13. As shown in FIG. 13, the confidential part specification screen 90 includes a document image display area 91, a confidential part specification icon 92, a confidential part specification cancellation icon 93 and a format registration icon 94.

The document image display area 91 is used for displaying the document image in which the fill-in areas 95 corresponding to the positional data are indicated. Thanks to the display of the fill-in areas according to the positional data (called up in S130) prior to the determination of the fill-in areas, the user is allowed to take appropriate action (cancellation of the fill-in printing, modification of the fill-in areas, etc.) in a subsequent step. The functions of the confidential part specification icon 92 and the confidential part specification cancellation icon 93 are equivalent to those of the confidential part specification icon 82 and the confidential part specification cancellation icon 83 which have been explained referring to FIG. 5, and thus repeated explanation thereof is omitted here.

Returning to FIG. 12, after displaying the confidential part specification screen 90 (S132), the second MFP 40 checks whether the confidential part specification icon 92 or the confidential part specification cancellation icon 93 (see FIG. 13) has been selected by the user (S134).

If affirmative in S134 (S134: YES), the second MFP 40 modifies the positional data stored in the positional data memory 43b according to instructions inputted by the user viewing the document image displayed in the document image display area 91 of the confidential part specification screen 90 (S136).

Incidentally, when the positional data is modified according to an instruction by the user as above, the display positions of the fill-in areas 95 indicated in the document image display area 91 are also modified accordingly (see FIG. 13), by which the user is allowed to modify the fill-in areas 95 properly while viewing the currently specified fill-in areas 95.

On the other hand, if negative in S134 (S134: NO) or negative in S914 (S914: NO), the second MFP 40 advances to step S138 while skipping the step S136 (i.e. without modifying the positional data).

In the step S138 (reached after S136 or when negative in S134), the second MFP 40 judges whether the format registration icon 94 has been selected by the user. If negative in S138 (S138: NO), the second MFP 40 returns to the step S134. If affirmative in S138 (S138: YES), the second MFP 40 determines the current positional data as the positional data to be used for the fill-in printing (S140).

Subsequently, the second MFP 40 stores the positional data determined in S140 in the management format table 64a while associating the positional data with the management number acquired from the bar code 73 (S142). In this step S142, if the positional data has been modified based on a user's instruction, the positional data before the modification is overwritten with the modified positional data.

With this procedure, even when the positional data (called up based on the management number acquired from the bar code 73) has been modified, the modified positional data is stored in the management format table 64a (see FIG. 6) while being associated with the acquired management number. Thus, when the fill-in printing is executed again later for a confidential document 71 to which the same management number has been assigned, the modified positional data can be called up and used, by which the operating load on the user is lessened considerably.

By the above fill-in area determination process (S124) in which the fill-in areas are determined based on the positional data corresponding to (associated with) the management number, appropriate fill-in areas can be determined in a remarkably shorter time compared to cases where the fill-in areas are determined by scanning the whole document and analyzing the scanned image.

Further, since the positional data is called up based on the management number acquired from the bar code 73 and the fill-in areas are determined based on the positional data in the fill-in area determination process of this embodiment, optimum fill-in areas can be determined automatically (without the need of user operation) by previously making the bar code 73 of the confidential document 71 hold a management number corresponding to (associated with) positional data optimum for the confidential document 71.

Furthermore, in cases where the positional data called up in S130 is modified, the second MFP 40 is capable of determining the fill-in areas based on the modified positional data. Thus, even when the fill-in areas according to the positional data called up based on the management number do not coincide with the user's expectation, the user has only to modify part of the positional data (fill-in areas) not suiting the user's preferences or purposes, in which the operating load on the user for the determination/modification of the fill-in areas is extremely light.

While a description has been given above of a preferred embodiment in accordance with the present invention, the present invention is not to be restricted by the particular illustrative embodiment and a variety of modifications, design changes, etc. are possible without departing from the scope and spirit of the present invention described in the appended claims.

For example, while the first MFP 30 (executing the printing of the confidential document) and the second MFP 40 (executing the fill-in printing process (FIG. 11)) are provided separately in the printing system 1 of the above embodiment, the printing of the confidential document and the fill-in printing process (FIG. 11) may also be executed by one printer having the printer function. While the second MFP 40 is connected to the same LAN 70 as the other devices in the printing system 1 of the above embodiment, the second MFP 40 does not necessarily have to be connected to the same LAN 70.

While the confidential document 71 is created by the PC 10 by controlling the first MFP 30 in the above embodiment, it is also possible to make a single device (e.g. first MFP 30) having a printer unit create the confidential document 71. In this case, the printing of the confidential document 71 having the bar code 73 (identifier) is executed by the printer unit of the device, and the control of the printer unit, etc. for the creation of the confidential document 71 having the bar code 73 (print control according to the confidential document preparation process of FIG. 8) is carried out by the CPU of the device according to a print control program stored in the device.

While the management format table 64a and the fill-in printing history table 64b are stored in the server 60 in the above embodiment, the tables 64a and 64b may also be stored in the PC 10, the first MFP 30 and/or the second MFP 40.

While a one-dimensional bar code is employed in the above embodiment as the identifier to be used for determining the fill-in areas, identifiers of other types (two-dimensional code for holding encoded data, IC tag for holding the management number, etc.) may also be employed as the identifier.

While the identifier (e.g. bar code 73) is used for holding the management number in the above embodiment, the identifier may also be used for holding the positional data (representing the positions of the fill-in areas 74) itself, for example. In this case, the use of an identifier having a relatively large data capacity (two-dimensional code, wireless tag, etc.) is desirable.

While the management number (example of management data) is held in the identifier (e.g. bar code 73) in the above embodiment, it is also possible to associate each format with a format name (“business card”, “customer information”, etc.) and call up a corresponding format when a format name is inputted by the user. In this case, the format name serves as the management data.

While the fill-in areas 74 are determined based on the management number acquired from the identifier (e.g. bar code 73) in the fill-in printing process (FIG. 11) in the above embodiment, it is also possible, for example, to add identifiers (e.g. bar codes 73) to multiple parts of the confidential document 71 so that each area between a pair of identifiers will be determined as a fill-in area 74.

While positional data that has been associated with exactly the same file size as that of the document image data (print target) is selected in the steps S912 and S911 of the format selection process (S4) in the above embodiment, the steps S912 and S911 may also be configured to select positional data that has been associated with a file size within a prescribed range of the file size of the document image data (i.e. a file size whose difference from that of the document image data is a prescribed value or less). With such a configuration, positional data corresponding to the document image data (print target) can be selected successfully even when the file size of the document image data has changed slightly due to a little modification made to the document image data after the previous confidential document preparation process.

Similarly, while positional data that has been associated with exactly the same file creation date/time as that of the document image data (print target) is selected in the steps S914 and S911 of the format selection process (S4), the steps S914 and S911 may also be configured to select positional data that has been associated with file creation date/time within a prescribed range of the file creation date/time of the document image data (i.e. file creation date/time whose difference from that of the document image data is a prescribed time period or less).

In the steps S11 and S12 of the confidential document preparation process (FIG. 8), the positional data of the selected format (called up in S10) may be determined as the positional data representing the positions of the fill-in areas not only when the fill-in areas (represented by the positional data of the selected format) are judged to overlap with a character (printed according to the document image data) but also when the fill-in areas are judged to overlap with an image.

While the ink which is used for the fill-in printing is not particularly restricted in the above embodiment, the fill-in printing may be executed by use of waste ink which has been purged (drawn out) from the print head during the cleaning operation, for example. In cases where multiple color inks are usable, the fill-in printing may be executed by use of one of the color inks whose purge time is the soonest. The fill-in printing may also be conducted using a color similar to that of the background of the document image, by judging the background color based on the document image data.

What is claimed is:

1. A printing device comprising:
a scanning unit which scans and recognizes an identifier which has been added to a printed sheet to be used for determining one or more fill-in areas;
a determination unit which determines the fill-in areas for the printed sheet based on the identifier recognized by the scanning unit; and
a fill-in printing unit which fills in the fill-in areas determined by the determination unit by executing printing on the printed sheet.

2. The printing device according to claim 1, further comprising a call-up unit which calls up positional data representing positions of the fill-in areas from a storage unit in which the positional data is stored while being associated with management data, wherein:
the scanning unit acquires the management data from the recognized identifier, and
the determination unit determines the fill-in areas based on positional data which is called up from the storage unit by the call-up unit as positional data associated with the management data acquired by the scanning unit.

3. The printing device according to claim 2, wherein:
the storage unit stores document image data corresponding to a document image already printed on the sheet, to which the fill-in printing based on the positional data is executed, while associating the document image data with the positional data, and
the determination unit displays a document image indicating the fill-in areas on a display screen prior to the execution of the fill-in printing by the fill-in printing unit by use of the positional data and the document image data stored in the storage unit while being associated with the positional data.

4. The printing device according to claim 3, wherein the determination unit includes a positional data modification unit which modifies the positional data according to an instruction inputted by a user based on the document image displayed on the display screen.

5. The printing system according to claim 4, wherein the printing unit further includes a fill-in printing history registration unit which stores the positional data modified by the positional data modification unit in a fill-in printing history storage unit while associating the positional data with the management data acquired by the scanning unit after the fill-in printing has been executed by the fill-in printing unit.

6. The printing device according to claim 1, further comprising:
a carriage equipped with a print head for discharging ink onto the sheet and being movable in a width direction of the sheet; and
an optical sensor provided on the carriage and including a light-emitting element and a photoreceptor element, wherein:
the identifier is an identifier printed on the sheet, and
the scanning unit recognizes the identifier using the optical sensor.

7. A computer-readable record medium storing computer-readable instructions that cause a print control device, for controlling a first printing unit which prints a document image on a sheet, to execute:
a positional data determination step of determining positional data representing positions of one or more fill-in areas for document image data corresponding to the document image;
an addition instruction step of instructing the first printing unit to add an identifier, to be used for acquiring the positional data determined by the positional data determination step, to the sheet; and
a print instruction step of instructing the first printing unit to execute the printing of the document image corresponding to the document image data on the sheet to which the identifier is added according to the instruction by the addition instruction step.

8. The computer-readable record medium according to claim 7, further storing computer-readable instructions that cause the print control device to execute a new registration step of newly storing the positional data determined by the positional data determination step in a storage unit while associating the positional data with management data,
wherein the addition instruction step instructs the first printing unit to add an identifier that holds the management data newly stored in the storage unit by the new registration step to the sheet.

9. The computer-readable record medium according to claim 8, wherein:
the storage unit stores the document image data and the positional data representing the positions of the fill-in areas while associating them with the management data, and
the computer-readable record medium further stores computer-readable instructions that cause the print control device to execute:
a selection step of selecting a piece of positional data from all the positional data stored in the storage unit; and
a selected data displaying step of displaying a document image indicating the fill-in areas on a display screen based on the positional data selected by the selection step and the document image data stored in the storage unit while being associated with the positional data,
wherein the positional data determination step determines the positional data representing the positions of the fill-in areas for the document image data based on the positional data selected by the selection step after the display by the selected data displaying step.

10. The computer-readable record medium according to claim 8, further storing computer-readable instructions that cause the print control device to execute:
a selection step of selecting a piece of positional data from all the positional data stored in the storage unit; and
an overlap judgment step of judging whether the fill-in areas represented by the positional data selected by the selection step overlap with a printing position of a character or an image in the document image printed according to the document image data,
wherein the positional data determination step determines the positional data selected by the selection step as the positional data representing the positions of the fill-in areas on condition that the overlap judgment step judges that the fill-in areas overlap with the printing position of a character or an image.

11. The computer-readable record medium according to claim 9, further storing computer-readable instructions that cause the print control device to execute a management data receiving step of receiving an input of management data from a user,
wherein the selection step selects positional data that has been stored in the storage unit while being associated with the management data received by the management data receiving step.

12. The computer-readable record medium according to claim 9, wherein:
the storage unit stores the positional data determined by the positional data determination step and a file name of the document image data for which the fill-in areas represented by the positional data are employed while associating the positional data and the file name with each other, and
when a file name coinciding with the file name of the document image data as the print target of the print instruction step has already been stored in the storage unit, the selection step selects the positional data that has been associated with the already stored file name.

13. The computer-readable record medium according to claim 9, wherein:
the storage unit stores the positional data determined by the positional data determination step and size of the document image data for which the fill-in areas represented by the positional data are employed while associating the positional data and the size with each other, and
when size whose difference from the size of the document image data as the print target of the print instruction step is a prescribed value or less has already been stored in the storage unit, the selection step selects the positional data that has been associated with the already stored size.

14. The computer-readable record medium according to claim 9, wherein:
the storage unit stores the positional data determined by the positional data determination step and creation date/time of the document image data for which the fill-in areas represented by the positional data are employed while associating the positional data and the creation date/time with each other, and
when creation date/time whose difference from the creation date/time of the document image data as the print target of the print instruction step is a prescribed time period or less has already been stored in the storage unit, the selection step selects the positional data that has been associated with the already stored creation date/time.

15. The computer-readable record medium according to claim 7, further storing computer-readable instructions that cause the print control device to execute:
a printout displaying step of displaying the document image, to be printed on the sheet according to the document image data as the print target of the print instruction step, on a display screen; and
a user input receiving step of receiving a user input specifying one or more fill-in areas in the document image displayed by the printout displaying step,
wherein the positional data determination step includes a step of determining the positional data based on the user input received by the user input receiving step.

16. A printing system comprising a first printing unit which prints a document image on a sheet and a print control device which controls the first printing unit, wherein the print control device includes:
a positional data determination unit which determines positional data representing positions of one or more fill-in areas for document image data corresponding to the document image;
an addition instruction unit which instructs the first printing unit to add an identifier, to be used for acquiring the positional data determined by the positional data determination unit, to the sheet; and
a print instruction unit which instructs the first printing unit to execute the printing of the document image corresponding to the document image data on the sheet to which the identifier is added according to the instruction by the addition instruction unit.

17. The printing system according to claim 16, further comprising a second printing unit and a storage unit which stores the positional data determined by the positional data determination unit while associating the positional data with management data, wherein the second printing unit includes:
a scanning unit which scans and recognizes the identifier which has been added to the sheet according to the instruction by the addition instruction unit and acquires the management data from the identifier;
a call-up unit which calls up the positional data associated with the management data acquired by the scanning unit from the storage unit;
a fill-in area determination unit which determines one or more fill-in areas based on the positional data called up by the call-up unit; and
a fill-in printing unit which fills in the fill-in areas determined by the fill-in area determination unit by executing printing on the sheet having the identifier.

18. The printing system according to claim 17, wherein:
the storage unit stores at least one selected from a file name, size and creation date/time of the document image data for which the positional data is employed while associating it with the management data, and
the print control device further includes a selection unit which selects positional data that has been associated with a file name coinciding with the file name of the document image data as the print target of the print instruction unit, positional data that has been associated with size whose difference from the size of the document image data is a prescribed value or less, or positional data that has been associated with creation date/time whose difference from the creation date/time of the document image data is a prescribed time period or less, and
the positional data determination unit determines the positional data representing the positions of the fill-in areas based on the positional data selected by the selection unit.

19. The printing system according to claim 18, wherein:
the second printing unit further includes a positional data modification unit which modifies the positional data called up by the call-up unit based on an instruction by a user, and
the fill-in area determination unit determines the fill-in areas based on the positional data modified by the positional data modification unit, and
the second printing unit further includes a fill-in printing history registration unit which stores the positional data modified by the positional data modification unit in a fill-in printing history storage unit while associating the positional data with the management data acquired by the scanning unit after the fill-in printing has been executed by the fill-in printing unit.
